(19) United States
(12) Patent Application Publication
(10) Pub. No.: US 2008/0268665 A1
(43) Pub. Date: Oct. 30, 2008

(54) TRANSFER PLATE AND MOTHERBOARD

(75) Inventor: Chieh-Shien Lin, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTeK COMPUTER INC., Taipei (TW)

(21) Appl. No.: 12/109,349

(22) Filed: Apr. 25, 2008

(30) Foreign Application Priority Data
Apr. 27, 2007 (TW) 96115042

(51) Int. Cl. H01R 12/00

(52) U.S. Cl. 439/59

(57) ABSTRACT

A transfer plate includes a slot and a transfer circuit. The slot has a plurality of terminals, wherein the terminals are suitable for a first memory module. One side of the transfer circuit is electrically connected to the terminals, and the other side of the transfer circuit has a plurality of connecting fingers suitable for a second memory module. The connecting fingers have a plurality of equality pins and at least a reserved pin, and the second terminals have a plurality of equality pins correspondingly electrically connected to the equality pins of the connecting fingers. When the reserved pin is electrically connected to one of a plurality of pins in a base plate, the reserved pin is used as a detecting pin for notifying the base plate that the slot is suitable for the first memory module now.

### CROSS-REFERENCE TO RELATED APPLICATION

This application claims the priority benefit of Taiwan application serial no. 96115042, filed on Apr. 27, 2007. The entirety of the above-mentioned patent application is hereby incorporated by reference herein and made a part of specification.

### BACKGROUND OF THE INVENTION

1. Field of the Invention

The invention relates to a motherboard and, more particularly, to a motherboard to which a second-generation double data rate (DDR2) memory module and a third-generation double data rate (DDR3) memory module are applied at the same time.

2. Description of the Related Art

A common personal computer system mostly consists of a motherboard, an interface card and peripheral devices, and the motherboard is regarded as the heart of the computer system. In addition to having a central processing unit (CPU), a chip set and a slot for installing the interface card, the motherboard has a plurality of (which are often four) memory module slots for installing memory modules. One memory module consists of a plurality of memory elements, and different number of memory modules can be installed on the motherboard according to the requirement of a user.

One type of the memory used in the personal computer is a synchronous dynamic random access memory (SDRAM), and the operation of the SDRAM is that data is accessed on the rising edge of a system clock signal.

For a double data rate dynamic random access memory (DDR DRAM), data can be accessed on the rising edge and the falling edge of the system clock signal, and therefore, the task completed by the SDRAM in two cycles can be completed by the DDR DRAM in one cycle. Compared with performance of the SDRAM having a same rate, the performance of the DDR DRAM is double of the performance of the SDRAM, and therefore, the DDR DRAM is the first choice of users.

To meet the requirement of users for a data transfer rate, the DDR DRAM gradually develops from the first-generation DDR (DDR1), the second-generation DDR (DDR2) to the third-generation DDR (DDR3). When the data transfer rate of the DDR2 reaches 800 MHz, the operating frequency of a kernel reaches 200 MHz, and therefore, it is difficult to further increase the data transfer rate. The DDR 3 having a high data transfer rate, a further advanced topological structure of address or command and control serial buses and low power consumption is a mainstream product now.

Since the DDR3 is improved on the basis of the DDR2, and it has functions (such as a reset function and a ZQ calibration function) not owned by the DDR2, the mode of arranging pins of the DDR3 is different from that of the DDR2. Generally, the DRAM slot on the motherboard manufactured by one supplier can only receive the DDR3 memory module or the DDR2 memory module, and therefore, the user can only select the DDR DRAM cooperating with the system of the motherboard.

To meet the above requirement, some of the four DRAM slots on the motherboard are designed as slots for receiving DDR3 memory modules, and the other DRAM slots are designed as slots for receiving DDR2 memory modules. However, only one type of the slots can be selectively used according to the system of the motherboard, and therefore, the DDR3 memory modules and the DDR2 memory modules cannot be used at the same time. In this way, the upper limit of using memories is limited.

### BRIEF SUMMARY OF THE INVENTION

The invention provides a transfer plate, and signal lines of a second-generation double data rate (DDR2) memory module can be rearranged via the transfer plate, and then the DDR2 module is applied to a motherboard supporting a third-generation double data rate (DDR3) system.

The invention provides a motherboard which can support a DDR2 system and a DDR3 system at the same time.

To achieve the above or other objectives, the invention provides a transfer plate including a slot and a transfer circuit. The slot has a plurality of terminals suitable for a first memory module. One side of the transfer circuit is electrically connected to the terminals, and the other side of the transfer circuit has a plurality of connecting fingers which are suitable for a second memory module. The connecting fingers have a plurality of equality pins and at least a reserved pin, and the terminals have a plurality of equality pins correspondingly electrically connected to the equality pins of the connecting fingers. When the reserved pin is electrically connected to one of a plurality of pins in a base plate, the reserved pin is used as a detecting pin for notifying the base plate that the slot is suitable for the first memory module now.

In one embodiment of the invention, the equality pins include address lines, control lines and data lines.

In one embodiment of the invention, the terminals include address terminals, control terminals and data terminals, and the address lines, the control lines and the data lines are correspondingly connected to the address terminals, the control terminals and the data terminals, respectively.

In one embodiment of the invention, the above terminals include a plurality of reserved terminals.

In one embodiment of the invention, the reserved pins are correspondingly connected to the reserved terminals, respectively.

In one embodiment of the invention, parts of the reserved pins are used as detecting pins.

The invention further provides a motherboard including a base plate and a transfer plate. The base plate has a first slot, and a plurality of first terminals are provided in the first slot. The first terminals are suitable to be correspondingly electrically connected to a second memory module. The transfer plate is provided in the first slot, and it includes a second slot and a transfer circuit. The second slot has a plurality of second terminals, and the second terminals are suitable to be correspondingly electrically connected to a first memory module. One side of the transfer circuit is electrically connected to the second terminals, and the other side of the transfer circuit has a plurality of connecting fingers which are suitable for a second memory module. The connecting fingers have a plurality of equality pins and at least a reserved pin, and the second terminals have a plurality of equality pins correspondingly electrically connected to the equality pins of the connecting fingers. When the reserved pin is electrically connected to one of the first terminals, the reserved pin is used as a detecting pin for notifying the base plate that the second slot is used.

In one embodiment of the invention, the base plate is a printed circuit board.

In one embodiment of the invention, the equality pins include address lines, control lines and data lines.

In one embodiment of the invention, the first terminals include address terminals, control terminals and data terminals, and the address lines, the control lines and the data lines are correspondingly electrically connected to the address terminals, the control terminals and the data terminals, respectively.

In one embodiment of the invention, the second terminals include address terminals, control terminals and data terminals, and the address lines, the control lines and the data lines are correspondingly connected to the address terminals, the control terminals and the data terminals, respectively.

In one embodiment of the invention, the first and second terminals further include a plurality of reserved terminals.

In one embodiment of the invention, the reserved pins are correspondingly connected to the reserved terminals, respectively.

In one embodiment of the invention, parts of the reserved pins are used as detecting pins.

In one embodiment of the invention, the motherboard further includes a plurality of electronic elements provided on the base plate.

In one embodiment of the invention, the electronic elements include a capacitance, an inductance or a resistance.

Via the transfer circuit of the transfer plate of the invention, the second connecting fingers of the memory module which is incompatible with the slot of the motherboard are rearranged to be the first connecting fingers which are compatible with the slot of the motherboard, and then the memory module can be provided in the slot of the motherboard. Therefore, the transfer plate and the motherboard using the same of the invention are convenient to be used.

These and other features, aspects, and advantages of the present invention will become better understood with regard to the following description, appended claims, and accompanying drawings.

### BRIEF DESCRIPTION OF THE SEVERAL VIEWS OF THE DRAWINGS

FIG. 1A is a schematic diagram showing a motherboard according to one embodiment of the invention;

FIG. 1B is an exploded diagram showing the motherboard in FIG. 1A; and FIG. 2 is a schematic diagram showing a memory module.

### DETAILED DESCRIPTION OF THE EMBODIMENTS

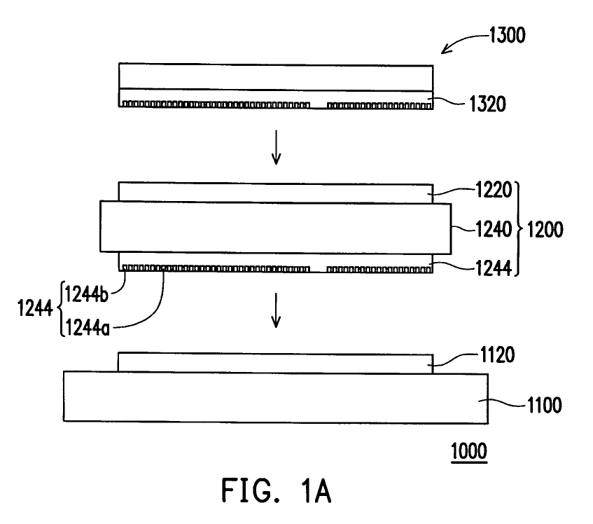

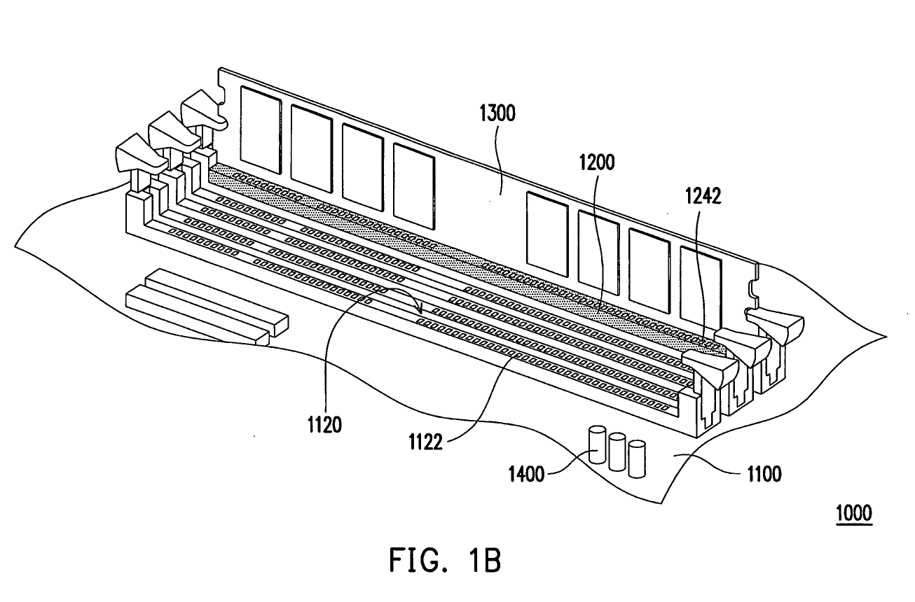

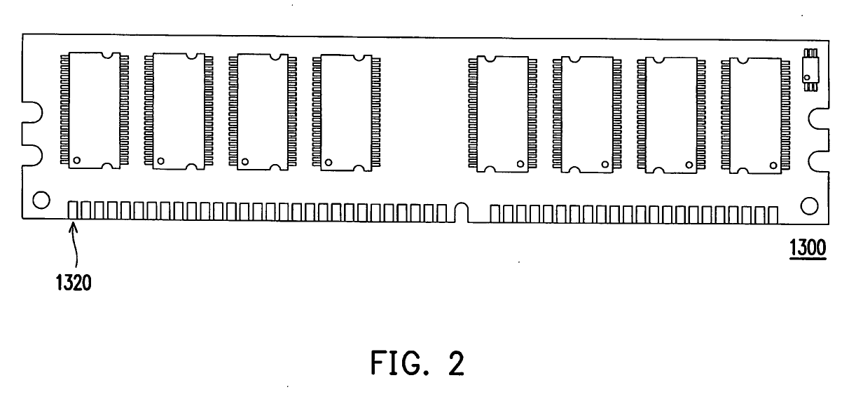

FIG. 1A is a schematic diagram showing a motherboard according to one embodiment of the invention, and FIG. 1B is an exploded diagram showing the motherboard in FIG. 1A. As shown in FIG. 1A and FIG. 1B, a motherboard 1000 includes a base plate 1100, a transfer plate 1200 and a memory module 1300. The base plate 1100 has a first slot 1120, and the base plate 1100 of the embodiment is a printed circuit board. A plurality of first terminals 1122 are provided in the first slot 1120, and the first terminals 1122 include address terminals (not marked), control terminals (not marked), data terminals (not marked) and reserved terminals (not marked).

The first terminals 1122 are arranged according to the third-generation double data rate (DDR3) standard, and therefore, a DDR3 memory module is suitable to be inserted into the first slot 1120, and the first terminals 1122 are electrically connected to connecting fingers (golden finger) of the DDR3 memory module.

The transfer plate 1200 includes a second slot 1220 and a transfer circuit 1240. One side of the transfer circuit 1240 has second terminals 1242, and the other side of the transfer circuit 1240 has first connecting fingers 1244. The first connecting fingers 1244 of the embodiment include a plurality of first equality pins 1244a and a plurality of reserved pins 1244b. The first equality pins 1244a include signal lines such as address lines (not marked), control lines (not marked), data lines ((not marked)) and so on. The signal lines are used to record, transfer, control and store data to a chip.

In detail, the address lines are, for example, a0 to a15, the control lines are, for example, CS1#, and the data lines are, for example, DQ0, etc. The reserved pins 1244b are, for example, DQS10#, DQS11#, etc. Parts of the reserved pins 1244b are detecting pins, and the detecting pins are used to detect whether the memory module is a second-generation double data rate (DDR2) memory module or a DDR3 memory module.

The address terminals, the control terminals and the data terminals of the first terminals 1122 are provided correspondingly to the address lines, the control lines and the data lines of the first connecting fingers 1244. In other words, the address terminals are corresponding to a0 to a15, the control terminals are corresponding to CS1#, etc., and the data terminals are corresponding to DQ0, etc. The reserved terminals are NC/DQS9N, NC/DQS10N, etc.

From the above, the second terminals 1242 are provided in the second slot 1220, and the second terminals 1242 are exposed from the second slot 1220. The second terminals 1242 of the embodiment are arranged according to the DDR2 standard, and therefore, a DDR2 memory module is suitable to be inserted into the second slot 1220. The first connecting fingers 1244 and the second terminals 1242 are correspondingly connected to each other, and the first connecting fingers 1244 are arranged according to the standard of the DDR3 memory module.

Similar to the first terminals 1122, the second terminals 1242 also include address terminals (not marked), control terminals (not marked), and data terminals (not marked). Pins of the second terminals 1242 are correspondingly electrically connected to pins of the first connecting fingers 1244. The standard of the second terminals 1242 are about the same with the standard of the first terminals 1122, and the difference between them is the mode of arranging the address terminals, the control terminals, the data terminals and the reserved terminals, and then it is not described for concise purpose. The reserved terminals of the second terminals 1242 are selectively correspondingly connected to the reserved pins 1244b.

The second slot 1220 of the transfer plate 1200 can hold a DDR2 memory module. The first connecting fingers 1244 of the transfer plate 1200 are suitable to be inserted into the first slot 1120 with the DDR3 standard and are electrically connected to the first terminals 1122.

FIG. 2 is a schematic diagram showing a memory module. As shown in FIG. 1A, FIG. 1B and FIG. 2, the memory module 1300 is provided on the base plate 1100. The memory module 1300 of the embodiment is a DDR2 memory module and has a plurality of second connecting fingers 1320. The second connecting fingers 1320 are suitable to be electrically connected to the second terminals 1242 correspondingly.

Similarly, the second connecting fingers 1320 also have a plurality of second equality pins and a plurality of reserved pins. Similar to the first equality pins 1244a, the second equality pins also include address lines, control lines and data lines, and they are not described for concise purpose. The difference between the second equality pins and the first equality pins 1244a is the mode of arrange signal lines among pins.

When a user directly assembles a DDR3 memory module into the first slot 1120 on the base plate 1100, the detecting pin of the first terminals 1122 can detect that the standard of the memory module is the DDR3 standard, and then the motherboard 1000 can select to use a system corresponding to the DDR3 memory module.

The memory module 1300 of the embodiment is a DDR2 memory module, and it is incompatible with the first slot 1120 with the DDR3 standard. Therefore, when the memory module 1300 is directly inserted into the first slot 1120, the second connecting fingers 1320 and the first terminals 1122 cannot be correspondingly electrically connected to each other, completely. At that moment, the memory module 1300 cannot perform its function.

When the transfer plate 1200 is used to assemble the memory module 1300 on the base plate 1100, the memory module 1300 is inserted into the second slot 1220 of the transfer plate 1200 first to allow the second terminals 1242 of the transfer plate 1200 to be correctly connected to the second connecting fingers 1320 correspondingly, and then the second connecting fingers 1320 with the DDR2 standard are rearranged to be the first gold pins 1244 with the DDR3 standard via the transfer circuit 1240. Then, the first connecting fingers 1244 of the transfer plate 1200 are inserted into the first slot 1120. Via the transfer circuit 1240, the second connecting fingers 1320 with the DDR2 standard are rearranged to be the first connecting fingers 1244 with the DDR3 standard, the detecting pin of the first terminals 1122 can detect that the standard of the memory module 1300 is the DDR2 standard. At that moment, the motherboard 1000 selects to use a system corresponding to the DDR2 memory module. Therefore, the memory module 1300 can be electrically connected to the base plate 1100 via the transfer plate 1200, and the motherboard 1000 can select to use a corresponding system to enable the memory module 1300 to perform its complete function.

The memory module 1300 with the DDR2 standard can be applied to the base plate 1100 with a DDR3 system via the transfer plate 1200 of the embodiment, and the motherboard 1000 can also correspondingly switch its used system. Compared with the conventional technology, via the transfer plate 1200 of the embodiment, the user can randomly use the DDR2 memory module and the DDR3 memory module, and he does not have to select a single type of memory module because of the limitation of the system of the motherboard 1000. Therefore, the transfer plate 1200 and the motherboard 1000 of the embodiment bring great convenience for users.

The motherboard 1000 further includes a plurality of electronic elements 1400 provided on the base plate 1100, and the electronic elements 1400 include a capacitance, an inductance or a resistance. Persons having ordinary skill in the art can know the application and type of the electronic elements 1400 on the motherboard 1000 via other published reference, and they are not described for concise purpose.

To sum up, the transfer plate and the motherboard using the same of the invention can be used to enable the DDR2 memory module to be applied to the motherboard with the DDR3 system. The system of the motherboard can correspondingly switch to a suitable DDR2 or DDR3 system according to the signal detected by the detecting pin. Therefore, the user can select the standard of the memory module according to his requirement, which is not limited by the system supported by the motherboard. For the user, the transfer plate and the motherboard using the same of the invention has elasticity and convenience in use.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A transfer plate comprising:
a slot having a plurality of terminals, wherein the terminals are suitable for a first memory module; and
a transfer circuit, wherein one side of the transfer circuit is electrically connected to the terminals, the other side of the transfer circuit has a plurality of connecting fingers which are suitable for a second memory module, the connecting fingers have a plurality of equality pins and at least a reserved pin, the terminals have a plurality of equality pins correspondingly electrically connected to the equality pins of the connecting fingers, and when the reserved pin is electrically connected to one of a plurality of pins in a base plate, the reserved pin is used as a detecting pin for notifying the base plate being suitable for the first memory module.

2. The transfer plate according to claim 1, wherein the terminals comprise address terminals, control terminals and data terminals, the equality pins comprise address lines, control lines and data lines, and the address lines, the control lines and the data lines are correspondingly connected to the address terminals, the control terminals and the data terminals, respectively.

3. The transfer plate according to claim 1, wherein the terminals further comprise a plurality of reserved terminals, and the reserved pins are correspondingly connected to the reserved terminals, respectively.

4. A motherboard comprising:
a base plate having a first slot, wherein a plurality of first terminals are provided in the first slot, and the first terminals are suitable to be electrically connected to a second memory module correspondingly;
a transfer plate provided in the first slot, the transfer plate comprising:
a second slot having a plurality of second terminals, wherein the second terminals are suitable to be electrically connected to a first memory module correspondingly; and
a transfer circuit, wherein one side of the transfer circuit is electrically connected to the second terminals, the other side of the transfer circuit has a plurality of connecting fingers which are suitable for the second memory module, the connecting fingers have a plurality of equality pins and at least a reserved pin, the second terminals have a plurality of equality pins correspondingly electrically connected to the equality pins of the connecting fingers, and when the reserved pin is electrically connected to one of the first terminals, the reserved pin is used as a detecting pin for notifying the base plate that the second slot is used.

5. The motherboard according to claim 4, wherein the second terminals comprise address terminals, control terminals and data terminals, the equality pins comprise address lines, control lines and data lines, and the address lines, the control lines and the data lines are correspondingly connected to the address terminals, the control terminals and the data terminals, respectively.

6. The motherboard according to claim 4, wherein the second terminals further comprise a plurality of reserved terminals, and the reserved pins are correspondingly connected to the reserved terminals, respectively.

7. The motherboard according to claim 4 further comprising a plurality of electronic elements provided on the base plate.

8. The motherboard according to claim 7, wherein the electronic elements comprise a capacitance, an inductance or a resistance.
